(19) United States
(12) Patent Application Publication
(10) Pub. No.: US 2012/0304530 A1
(43) Pub. Date: Dec. 6, 2012

(54) Bio-Oil Upgrading Process

(76) Inventors: Pallavi Chitta, West Valley, UT (US); Mukund Karanjikar, West Valley, UT (US)

(21) Appl. No.: 13/479,057

(22) Filed: May 23, 2012

Related U.S. Application Data
(60) Provisional application No. 61/493,099, filed on Jun. 3, 2011.

(51) Int. Cl. C10L 1/18; B01J 23/74; B01J 23/75; B01J 21/00; B01J 23/755

(52) U.S. Cl. 44/307; 502/74; 502/258; 502/327; 502/259; 502/260; 502/326

(57) ABSTRACT

A method for upgrading pyrolysis oil into a hydrocarbon fuel involves obtaining a quantity of pyrolysis oil, separating the pyrolysis oil into an organic phase and an aqueous phase, and then upgrading the organic phase into a hydrocarbon fuel by reacting the organic phase with hydrogen gas using a catalyst. The catalyst used in the reaction includes a support material, an active metal and a zirconia promoter material. The support material may be alumina, silica gel, carbon, silicalite or a zeolite material. The active metal may be copper, iron, nickel or cobalt. The zirconia promoter material may be zirconia itself, zirconia doped with Y, zirconia doped with Sc and zirconia doped with Yb.

### RELATED APPLICATION

This application claims the benefit of U.S. Provisional Patent Application Ser. No. 61/493,099 filed Jun. 3, 2011, entitled “Bio-Oil Upgrading Process.” This provisional application is expressly incorporated herein by reference.

### TECHNICAL FIELD

The present application relates to upgrading bio-oils so that such products may be used as fuels. More specifically, the present application relates to a process for upgrading pyrolysis oil into a usable fuel product.

### BACKGROUND

Many people have attempted to use “bio-oil,” such as Pyrolysis oil, as potential fuel source. Pyrolysis oil is extracted from biomass. As it contains carbon, hydrogen and oxygen atoms, many people have considered Pyrolysis oil as a potential hydrocarbon fuel.

However, bio-oil has many properties that make it difficult to use as a fuel. Some of these properties include its low heating value, incomplete volatility, acidity, instability, and incompatibility with standard petroleum fuels. Generally, these undesirable properties of pyrolysis oil result from the pyrolysis oil comprising oxygenated organic compounds. In other words, the presence of the oxygen-carbon bonds within these bio-oil molecules renders the bio-oil generally unsuitable for use as a hydrocarbon fuel source. Accordingly, various processes have been developed in an attempt to eliminate the oxygen atoms from the bio-oil, thereby transforming the bio-oil into usable hydrocarbon liquid fuel.

There are generally two (2) types of processes that have been attempted to eliminate oxygen atoms from the bio-oil, namely “hydro-treating” and “catalytic cracking.” In a “hydro-treating” process, the bio-oil compounds are reacted with hydrogen gas at high temperature and high pressure, thereby causing the oxygen atoms in the bio-oil to react with the hydrogen gas and form water. Unfortunately, this requirement for high temperature and high pressure hydrogen results in a process that is not economically viable. In a “catalytic cracking” process, the removal of oxygen atoms from the bio-oil occurs by using shape-selective catalysts which promote the conversion of the oxygen atoms into carbon dioxide (CO₂) and water molecules.

There are generally problems associated with both hydro-treating and catalytic cracking. Catalytic cracking is considered to be the less-expensive alternative to hydro-treating. Generally, the catalysts involved in catalytic cracking may be zeolite materials, such as a ZSM5 catalyst, or other catalysts including molecular sieves (SAPOs), mordenite and HY-zeolites. However, the use of such catalysts has been limited because the fuel formed using such catalysts is of low quality.

Recently, a new type of catalytic conversion process for converting bio-oils to fuel has been investigated. This process is referred to as “hydrodeoxygenation” and involves a high temperature, high pressure process in presence of hydrogen and a catalyst to remove the oxygen atoms from the bio-oil molecules. Most of the catalysts used for hydrodeoxygenation are some variations of Co—Mo, Ni—Mo or Fe—Mo impregnated on a support. However, these new types of hydrodeoxygenation catalysts have yet to provide an economical process for upgrading bio-oil molecules into a fuel product.

Accordingly, there is a need in the art for a new type of catalyst and process that will result in an economical upgrading of pyrolysis oil into a fuel product. Such a process and catalyst is disclosed herein.

### SUMMARY

The present embodiments relate to a new type of catalyst that may be used to upgrade pyrolysis oil. As used hereinthroughout, including the appended claims, the term pyrolysis oil means any bio-oil, including without limitation oil from biomass gasification, by-product oil from the transesterification of biomass, lipids or other oils extracted from biomass, or other oils derived from the treatment of, or extraction from, biomass. These catalysts will generally include a support material, an active metal (such as, for example, copper, nickel, manganese, iron or cobalt), and a zirconia promoter material. The zirconia promoter material may be zirconia itself (ZrO₂) or may be zirconia doped with d-block elements such as yttrium, scandium and ytterbium. The support material may be either an acidic support, such as alumina, or it may be a non-acidic support such as carbon, silica-gel, silicalite or even a zeolite material.

The catalysts of the present embodiments may be particularly adept at upgrading bio-oil. For example, the presence of zirconia on the surface of the catalysts improves the dispersion of the active metal (copper) throughout the surface of the catalyst. Such dispersion of copper metal results in smaller “active sites” that are more effective at converting the oxygen atoms in the bio-oil into CO₂. Second, doping zirconia with d-block elements leads to a structural oxygen deficiency on the surface of the catalyst, which then will promote a continuous renewal of oxygen atoms to the active site (and hence a higher ability of the catalyst to consistently reduce the oxygen atoms). It can be observed that the oxygen deficiency created is highly ordered and will act as molecular paths for a renewal of oxygen atoms to the surface of the catalyst by carrying oxygen through the matrix to another active site. While at the active site, the oxygen atom will effectively combine with hydrogen atoms to form water. The managed oxygen deficiency on the surface of the catalyst will further enhance the cleavage of C—O bonds preferentially over C—C bond cleavage, thereby further increasing the efficiency of the process.

### BRIEF DESCRIPTION OF THE DRAWINGS

FIG. 1 is flow diagram of an overall process of upgrading bio-oil according to the present embodiments;

FIG. 2 is a schematic view of a reaction vessel that may perform the bio-oil upgrading process according to the present embodiments;

FIG. 3 is a schematic view of a catalyst according to the present embodiments; and

FIG. 4 is a perspective view of a zirconia (ZrO₂) doped with Y.

### DETAILED DESCRIPTION

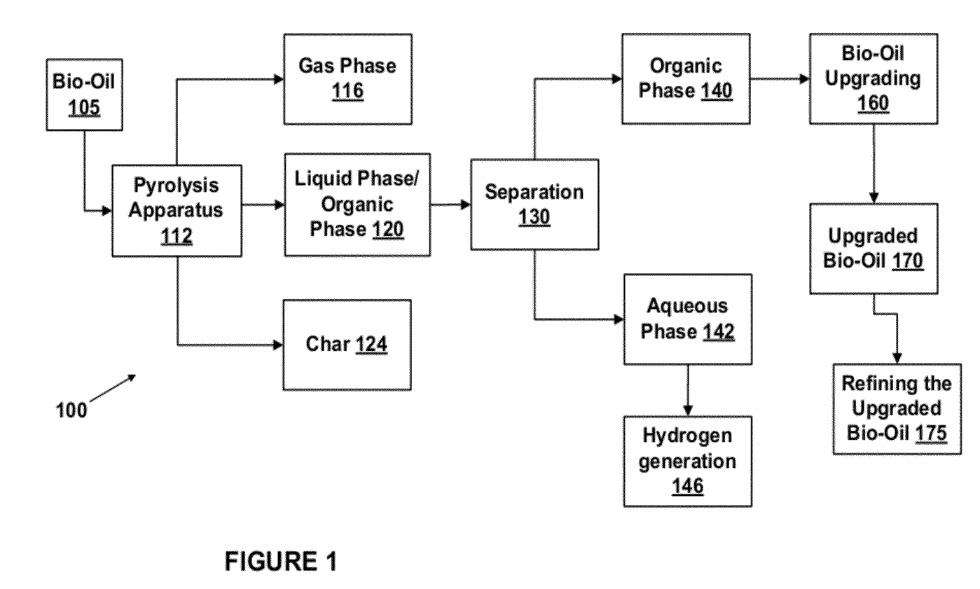

Referring now to FIG. 1, an overall process 100 for upgrading a bio-oil according to the present embodiments is illustrated. Specifically, the process 100 begins when a quantity of a bio-oil 105 is obtained. This bio-oil 105 may be pyrolysis oil that is obtained from bio-mass. Those skilled in the art will appreciate how the pyrolysis oil may be obtained.

The obtained quantity of bio-oil 105 is added to a pyrolysis apparatus 112 which may operate to separate the bio-oil 105 into a gas phase 116, char 124 and a liquid phase mixture 120. The liquid phase mixture 120 may include both an organic phase and an aqueous phase. Those skilled in the art will appreciate how to construct a pyrolysis apparatus 112 that is operable to separate out these constituents according to their relative state of matter. Further, those skilled in the art will appreciate how the gas phase 116 and/or the char 124 may be disposed of, re-used, burned as a heat source, etc.

A separation step 130 may be performed on the liquid phase mixture 120. Such a separation process is known in the art and results in an organic phase 140 being removed/separated and an aqueous phase 142. The organic phase 140 may then undergo a bio-oil upgrading process 160 using the catalysts and/or other techniques/materials described herein. This upgrading process results in an upgraded bio-oil product 170. If necessary, the upgraded bio-oil 170 may be further refined 175, processed, etc., in order to obtain better and/or more concentrated fuel product. The aqueous phase 142 may undergo further processing, as known in the art, to regenerate 146 hydrogen gas. If desired, this hydrogen gas that is regenerated may be used in the bio-oil upgrading process 160.

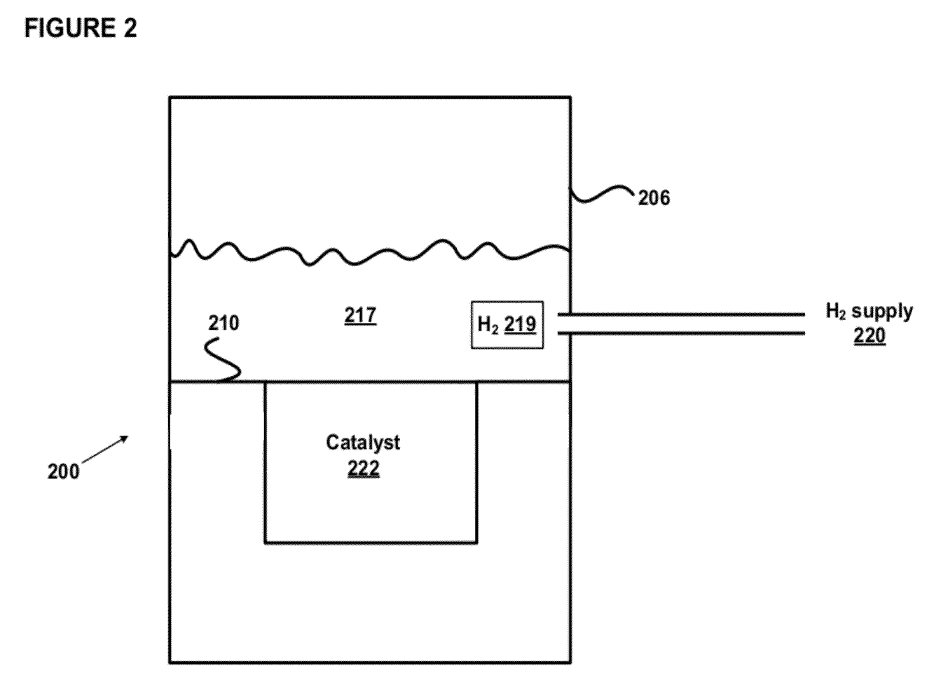

Referring now to FIG. 2, the bio-oil upgrading process 160 according to the present embodiments will be described in greater detail. Specifically, FIG. 2 is a schematic view of a vessel 200 in which the upgrading process 160 may be performed. The vessel 200 includes a housing 206. The housing 206 is made of sufficient rigidness such that it may withstand the high temperatures and high pressures associated with the upgrading process 160. For example, the reaction that upgrades the organic phase into the hydrocarbon fuel may be performed at temperatures between about 300° C. to about 450° C. and at pressures between about 50 psi to about 200 psi.

The high pressure may be supplied (at least in part) by hydrogen supply 220. In other words, hydrogen supply 220 may flood the vessel 200 with hydrogen gas 219, thereby providing a quantity of hydrogen gas that may react with the organic phase during the upgrading process. Other methods of increasing the pressure within the vessel 200, such as using nitrogen or an inert gas, may also be used. Obviously, the vessel 200 may be heated in order to achieve the reaction temperatures associated with the upgrading process.

In order to perform the upgrading process 160, a quantity of the organic phase 140 of the pyrolysis oil is added to the vessel 206. In some embodiments, this organic phase may be mixed with a solvent such as tetralin to form a reaction mixture 217. Of course, other solvents may also be used in the reaction mixture 217. In other embodiments, the reaction mixture 217 does not include a solvent and is made up, almost exclusively, of the organic phase 140.

It should be noted that, in some embodiments, the aqueous phase 142 of the pyrolysis oil is not added to the vessel 200. Rather, the aqueous phase 142 of the pyrolysis oil has already been separated out from the organic phase 140. This may be important because water soluble components, such as Na, Mg and Ca, have been separated from the organic phase, thereby reducing the possibility of such materials poisoning the catalyst. Such prior separation of the aqueous phase may also mitigate corrosion of the catalyst.

Once the reaction mixture 217 is within the vessel 217, the mixture 217 may be stirred (through methods known in the art), heated and pressurized in order to promote the reaction that will upgrade the pyrolysis oil. As noted above, such upgrading of the pyrolysis oil involves removing oxygen atoms from the bio-oil. In order to perform this reaction a catalyst 222 may be used. This catalyst 222 may be loaded in a catalyst basket 210, as shown in FIG. 2, or may otherwise be placed in the vessel 206 such that it comes into contact with the organic phase 140 and the hydrogen gas 219. The upgrading process involves a chemical reaction, fostered by the catalyst 222, in which the C—O bonds of the molecules of the organic phase are broken such that the resulting product that is a hydrocarbon fuel having C—C and/or C—H bonds. During this reaction, the oxygen atoms are eliminated from the bio-oil and converted into carbon dioxide and/or water. Once the hydrocarbon product is formed, it may be used as a fuel product. As noted above, further “refining” of this formed fuel product may be performed in order to render it more suitable for use as a hydrocarbon fuel. Using the methods of the present embodiments, the bio-oil may be upgraded substantially such that 95% of the oxygen atoms are removed from the bio-oil, thereby producing a refinery-grade hydrocarbon fuel product.

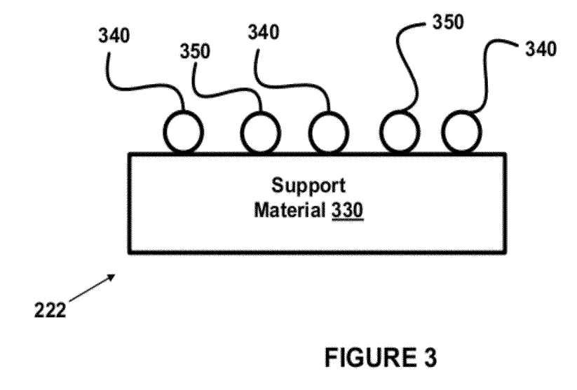

The catalyst 222 that may be used in the present embodiments will now be described. Specifically, a schematic of the catalyst 222 according to the present embodiments is shown in FIG. 3. The catalyst 222 may generally include a support material 330. As is known in the industry, a support material 330 is a material that is designed to “support” or provide a substrate for the active catalyst materials. In some embodiments, the support material 330 used in the catalyst 222 is selected from the group consisting of alumina, silica gel, carbon, silicalite and zeolites (including zeolites made from “fly ash” or other similar products). It should be noted that the present embodiments include support materials 330 that are acidic in nature (such as, for example, alumina) as well as other non-acidic materials (such as, for example, carbon, silica-gel and silicalite). In some embodiments, the use of non-acidic support materials 330 may be desirable because it has been found that some acidic support materials may cause the other materials in the catalyst to undesirably “coke” (char) during the upgrading process. Thus, the use of a support material 330 that is less active in coke formation may be desirable and may preserve the life-span of the catalyst.

In addition to a support material 330, the catalyst 222 may include an active metal 340. The active metal 340 may be positioned on the surface of the catalyst 222 and facilitates the upgrading reaction. In some embodiments, the active metal 340 may be selected from the group consisting of copper, iron, manganese, nickel and cobalt. In some embodiments, the active metal 340 is copper.

Further, the catalyst 222 may also include a zirconia promoter material 350. This zirconia promoter material 350 may also be positioned on the surface of the catalyst 222 proximate the active metal 340. The zirconia promoter material 350 will comprise zirconia (ZrO₂). In some embodiments the zirconia promoter material 350 may be pure zirconia. In other embodiments, the zirconia promoter material 350 may be zirconia that has been doped with a d-group metal such as Sc, Y, or Yb. Thus, the zirconia promoter material may be selected from the group consisting of zirconia, zirconia doped with Y, zirconia doped with Sc and zirconia doped with Yb.

It should be note that, in some embodiments, the use of zirconia doped with d-block elements in the catalyst may be desirable. Specifically, the d-block doped zirconia may be used as a promoter for transition metal catalyst (i.e., the active metal). This catalysis scheme may have two distinct merits. First, the presence of zirconia on the surface may improve copper dispersion. In other words, smaller sites (which are promoted by the presence of zirconia with the copper) have been demonstrated to be more effective at carbon (CO₂) reduction, thereby improving the performance of the catalyst. Second, zirconia doping with d-block elements may lead to a structural oxygen deficiency on the surface of the catalyst, which then will assist with continuous renewal of oxygen to the active site on the catalyst, and hence higher turnover frequency and a greater ability of the catalyst to react with oxygen atoms. It can be observed that the oxygen deficiency created is highly ordered and will act as molecular paths for surface renewal by carrying oxygen through the matrix to another active site (where the oxygen will effectively combine with hydrogen to form water). The managed oxygen deficiency will further enhance the cleavage of C—O bonds preferentially over C—C bond cleavage thereby further increasing the energy efficiency of the process.

In the embodiment shown in FIG. 3, the process that is used to react with the bio-oil may be a slurry phase hydrodeoxygenation (S-HDO) process that is performed on the organic phase of pyrolysis oil. Such a process may mitigate corrosion challenges by separating aqueous phase before HDO. Moreover, water soluble components such as Na, Mg and Ca may be separated out into the aqueous phase before the HDO process, thereby reducing the possibility of poisoning the catalyst.

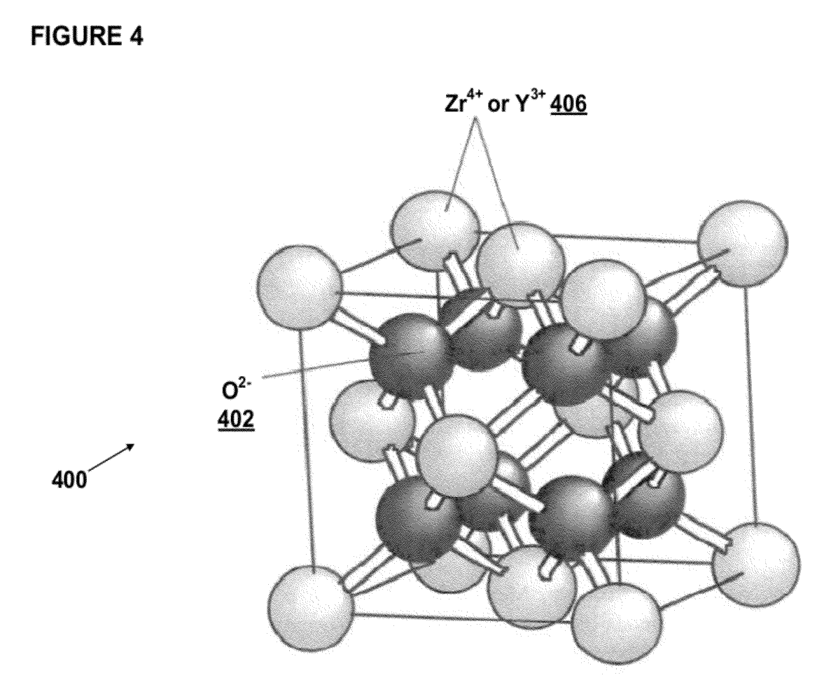

Referring now to FIG. 4, an exemplary structure is shown that will illustrate the oxygen deficiency of zirconia doped with a d-block element. Specifically, FIG. 4 shows a catalyst 400 that includes O²⁻ species 402 in a lattice structure with Zr⁴⁺ and/or Y³⁺ species 406. This structure shows the crystal structure of yttria doped zirconia. This structure inherently may create a deficiency of oxygen at the surface, thereby attracting oxygen to this site and facilitating the reaction.

Examples of the particular catalysts that may be formed include: Cu—ZrO₂—Y₂O₃—Al₂O₃ and Cu—ZrO₂—Al₂O₃

### Example

Carbon dioxide has been used as model compound to test the present catalysts due to its “highly oxidized state.” It is believed that a catalyst scheme effective at reducing CO₂ efficiently in presence of hydrogen will also be highly active for oxygen removal from other less oxygenated compounds such as pyrolysis oil.

Copper, zirconia and Yttria were used in formulation of three different catalysts. The catalysts were synthesized using incipient wetness method. Alumina pellets procured from CoorsTek (180 m²/g, gamma) were ground to 150-250 micron range. The ground alumina was dried overnight at 100° C. Upon cooling, alumina was impregnated with zirconium nitrate then dried overnight at 100° C. followed by calcination at 400° C. for four hours. The resulting material was impregnated with copper nitrate using the same procedure. The final catalyst (Cu—ZrO₂—Al₂O₃) was stored in a glass vial. The catalyst composition from the impregnated concentrations was calculated to be 10% Cu-1% Zr. Similar procedure was followed to prepare Cu—ZrO₂—Y₂O₃—Al₂O₃, the only difference being, zirconium nitrate solution was pre-mixed with Yttrium nitrate in a 100:8 ratio. To prepare the third catalyst, co-precipitated Yttria doped zirconia (10 m²/gm area) was impregnated with Cu followed by drying and calcinations. The Cu-YDZ (Yttria doped zirconia) catalyst was mixed with Cu—ZrO₂—Y₂O₃—Al₂O₃ in a 1:1 ratio (1:18 active sites). All the three catalysts were tested at 250° C., 200 CC/min net flow rate, 4:1 hydrogen to CO₂ ratio. Change in carbon dioxide concentration was measured using Varian MicroGC. The results of CO₂ reduction are summarized in the Table below. Carbon monoxide and methanol were observed as products of CO₂ reduction.

TABLE 1
Results of CO₂ Reduction

| | CO₂ reduction |
|---|---|
| Catalyst | efficiency (Single pass) |
| Cu-ZrO₂-Al₂O₃ | 2.82% |
| Cu-ZrO₂-Y₂O₃-Al₂O₃ | 24.12% |
| Cu-ZrO₂-Y₂O₃-Al₂O₃ + | 30.58% |
| Cu-ZrO₂-Y₂O₃-Al₂O₃ | |
| physical mixture | |

As seen from the foregoing Table, it can be concluded that addition of Yttria to the zirconia promoter, results into order of magnitude higher conversion. These results support the hypothesis of creating oxygen-deficient promoter structure to enhance reduction of highly oxidized species by efficient oxygen removal. Further addition of Yttria-doped-zirconia to the Y—Zr promoted catalyst results in further increased conversion, and thus further asserting the hypothesis.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A catalyst for upgrading pyrolysis oil into a hydrocarbon fuel, the catalyst comprising:
an active metal selected from the group consisting of copper, iron, nickel and cobalt;
a support material selected from the group consisting of alumina, silica gel, carbon, silicalite and zeolites; and
a zirconia promoter material, the zirconia promoter material being selected from the group consisting of zirconia doped with Y, zirconia doped with Sc and zirconia doped with Yb.

2. A catalyst as in claim 1, wherein the catalyst is selected from the group consisting of Cu—ZrO₂—Y₂O₃—Al₂O₃ and Cu—ZrO₂—Al₂O₃

3. A method for upgrading pyrolysis oil into a hydrocarbon fuel, the method comprising:
obtaining a quantity of pyrolysis oil;
separating the pyrolysis oil into an organic phase and an aqueous phase; and
upgrading the organic phase into a hydrocarbon fuel by reacting the organic phase with hydrogen gas using a catalyst, the catalyst comprising:
an active metal selected from the group consisting of copper, iron, manganese, nickel and cobalt; and
a zirconia promoter material, the zirconia promoter material being selected from the group consisting of zirconia, zirconia doped with Y, zirconia doped with Sc and zirconia doped with Yb.

4. The method of claim 3, further comprising refining the hydrocarbon fuel.

5. The method of claim 3, wherein the aqueous phase is used to regenerate hydrogen gas.

6. The method as in claim 3, wherein the catalyst further comprises a support material, wherein the support material is selected from the group consisting of alumina, silica gel, carbon, silicalite and zeolites.

7. The method of claim 3, further comprising removing gas phases and char materials from the pyrolysis oil prior to the organic phase being upgraded.

8. The method of claim 3, wherein the upgrading occurs at a temperature between about 300 and about 450° C.

9. The method of claim 3, wherein upgrading occurs at a pressure between about 50 and about 200 psi.

10. The method of claim 3, wherein ratio of the catalyst to the organic phase is between about 1:25 and about 5:25.

11. The method of claim 3, wherein the catalyst is selected from the group consisting of Cu—ZrO₂—Y₂O₃—Al₂O₃ and Cu—ZrO₂—Al₂O₃.
